(19) United States
(12) Patent Application Publication
(10) Pub. No.: US 2024/0369987 A1
(43) Pub. Date: Nov. 7, 2024

(54) FUNCTIONAL SAFETY MANAGEMENT SYSTEM AND METHOD FOR MANAGING FUNCTIONAL SAFETY STATUS OF PLURALITY OF EQUIPMENT UNDER CONTROL

(71) Applicant: Kone Corporation, Helsinki (FI)

(72) Inventor: Ari KATTAINEN, Helsinki (FI)

(73) Assignee: Kone Corporation, Helsinki (FI)

(21) Appl. No.: 18/772,888

(22) Filed: Jul. 15, 2024

Related U.S. Application Data
(63) Continuation of application No. PCT/EP2022/054238, filed on Feb. 21, 2022.

(51) Int. Cl. G05B 19/406

(52) U.S. Cl. CPC G05B 19/406; G05B 2219/50193

(57) ABSTRACT

A functional safety management system for and a method of managing functional safety of at least one equipment under control. The system comprises a data storage entity configured to store desired functional safety information related to a desired functional safety status of the equipment under control, and a functional safety management entity connected to the data storage entity for obtaining or receiving therefrom the desired functional safety information, and to the equipment under control for obtaining or receiving current functional safety status information related to a current functional safety status of the equipment under control. The functional safety management system is configured to perform a functional safety related operation based on information included in the current functional safety status information and the desired functional safety information.

### CROSS-REFERENCE TO RELATED APPLICATION

This application is a continuation of PCT International Application No. PCT/EP2022/054238 which has an International filing date of Feb. 21, 2022, the entire contents of which are incorporated herein by reference.

### FIELD OF THE INVENTION

The present invention relates in general to functional safety management systems and methods for managing functional safety status of equipment under control (EUC). In particular, however not exclusively, the present invention concerns a functional safety management system and a method for managing functional safety status of an EUC which is or is comprised in a transport system, such as an elevator, an escalator, or an automatic door.

### BACKGROUND

A transport system, such as an elevator, an escalator, or an automatic door, comprises components which may be manufactured by specialized companies, also referred to as original equipment manufacturers (OEM). Manufacturers regularly provide updates and revisions to the components by correcting design flaws and bugs, making software updates and revisions, adding new functionality, etc. These updates may have impact on reliability and/or functional safety of the transport system as well. The same holds true for other automation systems, such as factory assembly lines as well. For example, after discovery of a design flaw of an elevator component, or a change in regulations concerning elevators, all affected elevators should be reviewed at short notice to prevent comprising functional safety and to avoid any liability risks related thereto. Tracking down and reviewing all elevators involved can be a time- and resource-intensive undertaking.

Document US 2021/403277 A1 presents an elevator system having at least one movable component and at least one component generating a reference signal. The elevator system includes a controller, an output signal, and a controller tuner. The controller generates a control signal. The output signal is indicative of a movement of the at least one movable component of the elevator system based on the control signal. The controller tuner is communicatively coupled to the controller. The controller tuner receives the output signal and the reference signal to calculate an error signal. The controller tuner uses the error signal to calculate a corrected control signal and transmits the corrected control signal to the controller.

Document EP 3415454 A1 presents a device and a method for controlling an apparatus being an elevator, an escalator or automatic doors are provided, by which it is detected whether a fault is present in the apparatus, it is determined, when the fault is present, whether an automatic fault clearing may be carried out, and if it is determined that the automatic fault clearing may be carried out, the automatic fault clearing is performed by automatically clearing one or more faults.

Document EP 3438032 A1 presents a method for updating software of an elevator system. The method comprises adapting and/or configuring a new version of the software specifically for the elevator system, downloading the new version of the software, which has been adapted and/or configured specifically for the elevator system, onto a portable update device, connecting the portable update device with the elevator system, verifying that the new version of the software on the portable update device is software designated for the elevator system via verification means of the portable update device, and updating the software of the elevator system from an old version of the software to the new version of the software via the portable update device.

Document US 2018/157482 A1 presents a method of updating safety-related software in a people conveyor system, particularly in an elevator system. The method comprises providing an updated version of the safety-related software, storing the updated version of the safety-related software in a safety unit of the people conveyor system, activating the updated version of the safety-related software, activating including operating a software update activation switch permanently associated with the people conveyor system, and in case of successful activation of the updated version of the safety-related software, controlling the operation of the people conveyor system based on the updated version of the safety-related software.

Document JP 2002 020052 A presents a maintenance method for an elevator control device capable of appropriately renewing elevator control software. When correcting and changing the elevator control software, the corrected and changed elevator control software is transmitted from a control computer to a memory via modems and a public line at site so as to be renewed and stored. A check means checks the soundness of the elevator control software renewed and stored in the memory, when it is transmitted normally, an arithmetic operation means operates and controls the elevator based on the corrected and changed elevator control software.

### SUMMARY

An objective of the present invention is to provide a functional safety management system and a method for managing functional safety of an EUC. Another objective of the present invention is that the functional safety management system and the method can be used to conveniently verify that the components of the EUC fulfil functional safety requirements.

The objectives of the invention are reached by a functional safety management system and a method for managing functional safety of an EUC as defined by the respective independent claims.

According to a first aspect, a functional safety management system for a plurality of equipment under control (EUC) is provided. The system comprises a data storage entity configured to store desired functional safety information related to a desired functional safety status of the EUC, wherein the data storage entity is connected to an external information source for obtaining or receiving the desired functional safety information from the external information source, and a functional safety management entity connected to the data storage entity for obtaining or receiving therefrom the desired functional safety information, and to the plurality of EUC for obtaining or receiving current functional safety status information related to a current functional safety status of the EUC from each one of the plurality of equipment under control. The functional safety management system is configured to perform a functional safety related operation based on information included in the current functional safety status information and the desired functional safety information.

Term “functional safety” as used through the disclosure may refer to safety-related devices, systems and methods conforming with the functional safety standard IEC 61508.

The functional safety information may relate to one or several or each of the aspects of the functional safety status. For example, while the functional safety status may refer to relatively large number of different safety aspects of the EUC and to their status (current, desired, or recommended), the functional safety information may still relate to only one or a portion of them, or to a change in them.

The functional safety related operation may, preferably, be performed by the functional safety management entity. The functional safety management entity may be, for example, a server or server system. There may be executed a functional safety management software, and the functional safety management entity may optionally comprise a database. The functional safety management entity may be configured to perform the logical operations, such as decision, comparison and data collecting tasks.

Alternatively or in addition, the functional safety related operation may be a corrective action to change or at least to indicate a need for changing the current functional safety status towards the desired functional safety status.

Furthermore, in addition, the external information source may include recommended functional safety information related to the EUC and/or to one or several components of the EUC.

In various embodiments, the functional safety related operation may be a decision, a comparison, and/or a data collection operation. Furthermore, the comparison may include at least one selected from the group consisting of: comparison of current configuration of the EUC to a desired configuration of the EUC, comparison of an elapsed operation time of a component to a maximum allowable mission time of said component, comparison of hardware or software version of a component to the desired hardware or software version of said component.

In some embodiments, the functional safety management entity may be arranged physically at least partly at or in close vicinity with the EUC, such as a functionality to be performed by a control unit of the EUC.

Furthermore, the functional safety management entity may be arranged physically at least partly external with respect to the EUC.

The desired functional safety status may include at least one selected from the group consisting of: latest safety management rules, maximum allowable mission time set for specific component usage, estimated preliminary life time of a component, desired hardware or software version number, new set of control parameters of the EUC, information of verified compatible configurations of the EUC.

The current functional safety status information may include at least stored information indicated in an electrical nameplate mounted to a selected component of the EUC.

In various embodiments, the current functional safety status information may include, optionally in addition to the stored information indicated in the electrical nameplate, at least one selected from the group consisting of: manufacturing time, factory name or ID, component serial number, manufacturing batch, component hardware or software version number, control parameters of the EUC currently in use, number of starts of the EUC, component information of the EUC.

The at least one EUC may be a transport system or a factory assembly line. Furthermore, the EUC, if being a transport system, is one of the following: an elevator, an escalator, a travellator, an automatic door.

According to a second aspect, a method for managing functional safety status of at least one EUC is provided. The method comprises obtaining or receiving desired functional safety information related to a desired functional safety status of the EUC from a data storage, wherein the data storage entity is connected to an external information source for obtaining or receiving the desired functional safety information from the external information source, and obtaining or receiving current functional safety status information related to a current functional safety status of the EUC from each one of the plurality of EUC, and performing a functional safety related operation based on information included in the current functional safety status information and the desired functional safety information.

Furthermore, the method may comprise comparing the current functional safety status to the desired functional safety information.

In addition, the functional safety related operation may be a corrective action to change or at least to indicate a need for changing the current functional safety status towards the desired functional safety status.

According to a third aspect, a computer program product is provided. The computer program product comprises instructions which, when the program is executed by a computer system, such as of the functional safety management system, cause the computer system to carry out the method in accordance with the second aspect.

The present invention provides a functional safety management system and a method for managing functional safety of an EUC. The present invention provides advantages over known solutions in that it can easily be verified that the components of the EUCs or the EUCs themselves fulfil safety requirements based on the utilization of up-to-date information in a database of the functional safety management system and/or, for example, information provided by the OEM(s) of EUC(s).

Various other advantages will become clear to a skilled person based on the following detailed description.

The expression “a plurality of” may refer to any positive integer starting from two (2), that is, two, at least two, three, at least three, etc.

The terms “first”, “second” and “third” are herein used to distinguish one element from other element, and not to specially prioritize or order them, if not otherwise explicitly stated.

The exemplary embodiments of the present invention presented herein are not to be interpreted to pose limitations to the applicability of the appended claims. The verb “to comprise” is used herein as an open limitation that does not exclude the existence of also unrecited features. The features recited in depending claims are mutually freely combinable unless otherwise explicitly stated.

The novel features which are considered as characteristic of the present invention are set forth in particular in the appended claims. The present invention itself, however, both as to its construction and its method of operation, together with additional objectives and advantages thereof, will be best understood from the following description of specific embodiments when read in connection with the accompanying drawings.

### BRIEF DESCRIPTION OF FIGURES

Some embodiments of the invention are illustrated by way of example, and not by way of limitation, in the figures of the accompanying drawings.

FIGS. 1A and 1B illustrate schematically functional safety management systems.

FIGS. 2A-2C illustrate schematically functional safety management systems in connection with EUCs being transport systems.

FIG. 3 illustrates schematically a functional safety management system operating in connection with a plurality of EUCs.

FIG. 4 shows a flow diagram of a method.

### DETAILED DESCRIPTION OF SOME EMBODIMENTS

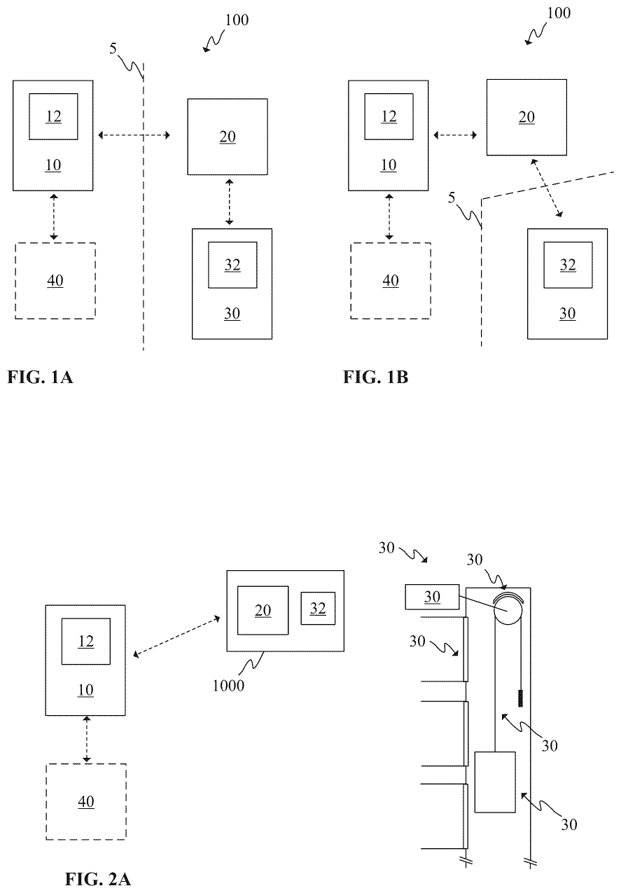

FIGS. 1A and 1B illustrate schematically functional safety management systems 100. The functional safety management system 100 may be configured to manage functional safety of at least one EUC 30. The system 100 comprises a data storage entity 10 configured to store desired functional safety information 12 related to a desired functional safety status of the equipment under control 30. The functional safety management system 100 also comprises a functional safety management entity 20 connected to the data storage entity 10 for obtaining or receiving therefrom the desired functional safety information 12, and to the equipment under control 30 for obtaining or receiving current functional safety status information 32 related to a current functional safety status of the equipment under control 30. The functional safety management system 10 is configured to perform a functional safety related operation based on information included in the current functional safety status information 32 and the desired functional safety information 12. Current functional safety status information may contain component information of the equipment under control 30. Such component information may contain information (such as manufacturing time, of, e.g., elevator suspension ropes, overspeed governor, brake or electronic circuit board of an elevator).

In various embodiments, information may be transmitted via the connection between the functional safety management entity 20 and the EUC 30 in both directions. Thus, the EUC 30 can receive information, commands, etc. from the functional safety management entity 20. On the other hand, the EUC 30 can provide information, such as, however not limited to, current functional safety status information 32 thereof.

The functional safety management system 100 may also comprise an external server 40, or at least a connection thereto.

In FIGS. 1A and 1B, there is shown a border 5. The border 5 schematically indicates that the area to the right of the border 5 represents the local environment of the EUC 30. The area to the left of the border 5 represents physically external environment relative to the EUC 30. Thus, in various embodiments, the functional safety management system 100 may be implemented as a functional safety management software (being or comprised in the functional safety management entity 20) running locally on, for example, an edge computing unit or a control unit of the EUC 30, such as comprising a processing unit, as indicated in FIG. 1A. Additionally or alternatively, the functional safety management software and/or the entity 20 may be on a remote cloud computing system or a remote server, that is external relative to the EUC 30, however, having at least a communication connection therebetween.

In some embodiments, there may be a main portion of the functional safety management entity 20 running, for example, the remote cloud computing system or the remote server, while there may also be a sub-portion of the functional safety management entity 20 being configured to run locally at the EUC 30, and be in connection with the main portion.

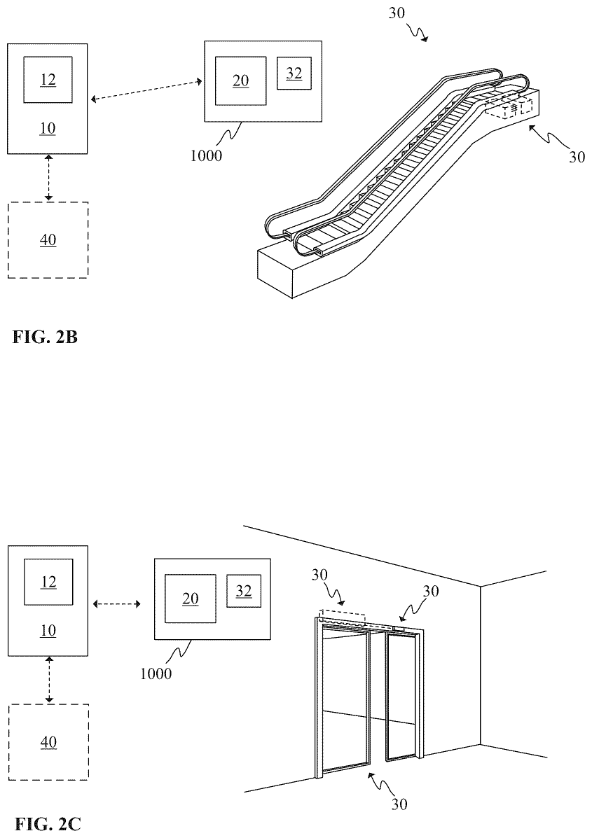

FIGS. 2A-2C illustrate schematically functional safety management systems 100 in connection with EUC 30, wherein the EUCs are transport systems, namely an elevator, an escalator, and an automatic door, respectively. A further example of the transport system is a travellator (not shown). The safety management entity 20 may be, however, is not limited to being, a part of the control unit 1000 of the EUC 30.

As described hereinbefore, the functional safety management entity 20 may be connected to a data storage entity 10. The data storage entity 10 may comprise a database operated by a database server.

The data storage entity 10 may provide up-to-date functional safety information 12 related to a desired functional safety status of the EUC 30. Such information may stipulate latest safety management rules, maximum allowable mission time set for specific component usage, such as based on a counter of the usage, estimated preliminary life time of a component, desired hardware or software version number, new set of EUC control parameters or information of verified compatible EUC configurations.

The data storage entity 10 may be further connected to various sources of information indicated by an optional external server 40 in FIGS. 1A-2C, such as to information databases and/or servers a plurality of OEM, to retrieve such up-to-date information.

Further, the functional safety management entity 20 may be connected to the EUC 30 to obtain safety-related information of current status of the EUC therefrom. Such status information may contain manufacturing time, factory name or id, component serial number, manufacturing batch, component hardware or software version number, EUC control parameters currently in use, number of EUC starts or other component information of the EUC. At least part of the status information may be memorized in an electrical nameplate mounted to a selected component of the EUC. The functional safety management entity 20 may be communicatively connected to the electrical nameplate to gather such information. According to an embodiment, the electrical nameplate may be mounted to a drive machine of a transport system, such as to an elevator hoisting machine.

The functional safety management entity 20 may be configured to perform logical operations, such as decision, comparison and data collecting tasks by processing said current status information 32 of the EUC 30 against said up-to-date information 12 of the data storage entity 10. The functional safety management entity 20 may set one or more rules based on the functional safety information 12. It may compare current configuration of an EUC 30 to a desired configuration, elapsed operation time of a component to maximum allowable mission time of the component, hardware or software version of a component to the desired version, etc. Thus, the criteria may related to the usage time being less than the mission time, or the software version being newer than or exactly some version number. In case of elevator, for instance, the comparison may relate to status of components such as the hoisting rope, brake, electrical drive, elevator car positioning device, over speed governor or limiter, safety gear, safety buffer, or electronic circuits.

For example, the current configuration differing from desired configuration can mean that one or more components of the EUC 30 are obsolete or worn; therefore a corrective revision e.g. maintenance or replacement of one or more components of the EUC 30 may be necessary.

Thus, the corrective action for changing the current status towards to desired status may be an indication, a message, or an alert, to a maintenance person and/or the owner of the EUC 30 to provide maintenance or to replace the component. On the other hand, in case of old or wrong software version, the corrective action may indeed the initialization of the updating or replacement process of the software.

According to various examples, the functional safety management entity 20 may take different measures based on said processing. It may issue a warning or a fault code for the EUC 30 and/or to an external entity, such as an indication of maintenance need to a service center in case current operational state of EUC 30 does not conform with the rules set for it or a component configuration differs from the desired configuration. The decision about criticality level of the warning or a fault code may be done either by or at the EUC 30, such as a control unit thereof, or in an external functional safety management entity 20. If done in the external functional safety management entity 20, it provides possibility to define the corrective action regarding the particular deviation in the functional safety status conveniently, such as in a more centralized manner.

The functional safety management entity 20 may also request operation continued with lowered performance level of the EUC 30, such as with a lowered speed of an elevator, an escalator, or a moving walk or travellator. Term “mission time” refers herein to the maximum period of time for which a system or subsystem can be used before it must be replaced. Finally, the functional safety management entity 20 may order the EUC 30 to be shut down in case severity of the anomaly is extensive.

Furthermore, an operation instruction may be issued in connection with the warning or a fault code. The operation instruction may be a character string or a QR code, a Uniform Resource Locator (URL) or an internet protocol (IP) address, or the like, based on which the maintenance person and/or the owner of the EUC 30 can obtain further details or information of the detected deviation between the desired and current functional safety statuses of the EUC 30. Furthermore, one or several corrective actions may also be obtained by utilizing the operation instruction.

FIG. 3 illustrates schematically a functional safety management system 100 operating in connection with a plurality of EUCs 30. According to an embodiment, the functional safety management entity 20 may be communicatively connected to a plurality of EUCs 30, such as to an elevator fleet, for receiving information of current status related to functional safety of the EUCs 30. As stated hereinbefore, additionally or alternatively, each EUC 30 may have its own functional safety management functionality, such as operating substantially independently or in connection with a local or external main portion of the functional safety management entity 20.

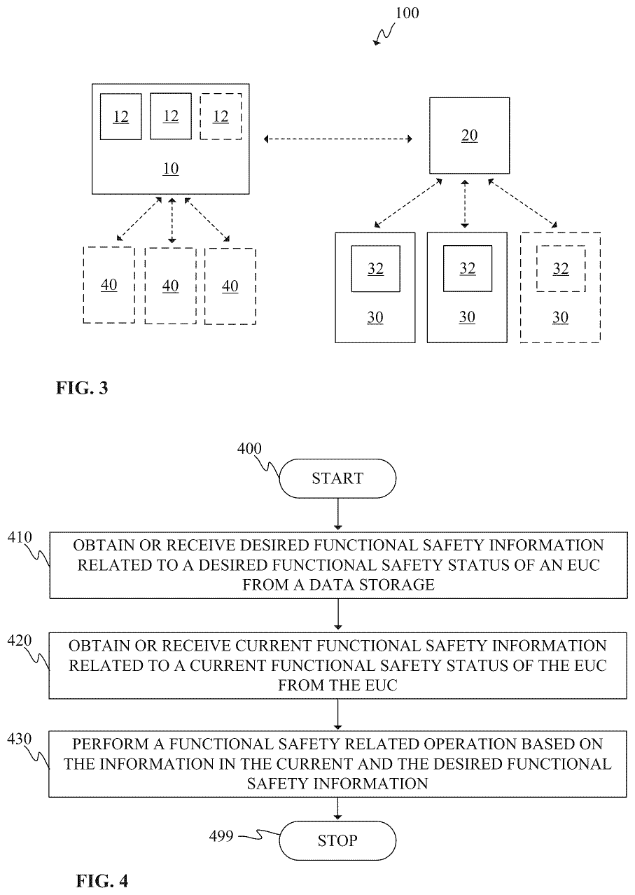

FIG. 4 shows a flow diagram of a method.

Item, or “step”, 400 refers to optional start-up phase of the method. Suitable equipment and components are obtained and systems assembled and configured for operation.

Item 410 refers to obtaining or receiving desired functional safety information 12 related to a desired functional safety status of the EUC 30 from a data storage 10.

Item 420 refers to obtaining or receiving current functional safety status information 32 related to a current functional safety status of the EUC 30 from the EUC 30, and

Item 430 refers to performing a functional safety related operation, such as issuing a warning, alert, or other indication, or performing a corrective measure, based on information included in the current functional safety status information 32 and the desired functional safety information 12, such as by the functional safety management entity 20 based on the comparison of the information to each other and/or utilizing certain pre-defined criteria.

Method execution may be stopped at step 499.

1. A functional safety management system for a plurality of equipment under control, the plurality of equipment under control being transport systems and one of the following: an elevator, an escalator, a travellator, an automatic door, the system comprising:
a data storage entity configured to store desired functional safety information related to a desired functional safety status of the equipment under control, wherein the data storage entity is connected to an external information source for obtaining or receiving the desired functional safety information from the external information source;
a functional safety management entity connected to the data storage entity for obtaining or receiving therefrom the desired functional safety information, and to the plurality of equipment under control to obtain or receive current functional safety status information related to a current functional safety status of the equipment under control from each one of the plurality of equipment under control, wherein the functional safety management entity is arranged physically external with respect to the equipment under control,
wherein the functional safety management system is configured to perform a functional safety related operation based on information included in the current functional safety status information and the desired functional safety information.

2. The functional safety management system of claim 1, wherein the functional safety related operation is performed by the functional safety management entity.

3. The functional safety management system of claim 1, wherein the functional safety related operation is a corrective action to change or at least to indicate a need for changing the current functional safety status towards the desired functional safety status.

4. The functional safety management system of claim 1, wherein the external information source includes recommended functional safety information related to the equipment under control and/or to one or several components of the equipment under control.

5. The functional safety management system of claim 1, wherein the functional safety related operation is a decision, a comparison, and/or a data collection operation.

6. The functional safety management system of claim 5, wherein the comparison includes at least one selected from the group consisting of: comparison of current configuration of the equipment under control to a desired configuration of the equipment under control, comparison of an elapsed operation time of a component to a maximum allowable mission time of said component, comparison of hardware or software version of a component to the desired hardware or software version of said component.

7. The functional safety management system of claim 1, wherein the functional safety management entity is arranged physically at the equipment under control, such as a functionality to be performed by a control unit of the equipment under control.

8. The functional safety management system of claim 1, wherein the desired functional safety status includes at least one selected from the group consisting of: latest safety management rules, maximum allowable mission time set for specific component usage, estimated preliminary life time of a component, desired hardware or software version number, new set of control parameters of the equipment under control, information of verified compatible configurations of the equipment under control.

9. The functional safety management system of claim 1, wherein the current functional safety status information includes at least stored information indicated in an electrical nameplate mounted to a selected component of the equipment under control.

10. The functional safety management system of claim 1, wherein the current functional safety status information includes, optionally in addition to the stored information indicated in the electrical nameplate, at least one selected from the group consisting of: manufacturing time, factory name or ID, component serial number, manufacturing batch, component hardware or software version number, control parameters of the equipment under control currently in use, number of starts of the equipment under control, component information of the equipment under control.

11. A method for managing functional safety status of a plurality of equipment under control, the plurality of equipment under control being transport systems and one of the following: an elevator, an escalator, a travellator, an automatic door, the method comprising:
obtaining or receiving, by a functional safety management entity, desired functional safety information related to a desired functional safety status of the equipment under control from a data storage, wherein the data storage entity is connected to an external information source for obtaining or receiving the desired functional safety information from the external information source, and wherein the functional safety management entity is arranged physically external with respect to the equipment under control,
obtaining or receiving, by the functional safety management entity, current functional safety status information related to a current functional safety status of the equipment under control from each one of the plurality of equipment under control, and
performing a functional safety related operation based on information included in the current functional safety status information and the desired functional safety information.

12. The method of claim 11, comprising comparing the current functional safety status to the desired functional safety status.

13. The method of claim 11, wherein the functional safety related operation is a corrective action to change or at least to indicate a need for changing the current functional safety status towards the desired functional safety status.

14. A computer program product comprising instructions which, when the program is executed by a computer system, cause the computer system to carry out the method of claim 11.
